(19) United States
(12) Patent Application Publication
(10) Pub. No.: US 2025/0116827 A1
(43) Pub. Date: Apr. 10, 2025

(54) CONNECTIVITY SYSTEM INTEGRATING KEYING ELEMENTS

(71) Applicant: CommScope Technologies LLC, Hickory, NC (US)

(72) Inventors: Michael Lawrence GURRERI, York, PA (US); William J. YOUNG, Plano, TX (US); Yang XU, Frisco, TX (US)

(73) Assignee: CommScope Technologies LLC, Hickory, NC (US)

(21) Appl. No.: 18/728,012

(22) PCT Filed: Jan. 6, 2023
(86) PCT No.: PCT/US2023/060251

§ 371 Date: Jul. 10, 2024

Related U.S. Application Data
(60) Provisional application No. 63/298,063, filed on Jan. 10, 2022.

(51) Int. Cl. G02B 6/40

(52) U.S. Cl. CPC G02B 6/403

(57) ABSTRACT

A fiber routing system including a plurality of two/multi fiber cables terminated at each end a two/multi fiber connector, wherein each of the two/multi fiber cables is a key up to key down arrangement; a plurality of two/multi fiber adapters each connecting two of the two/multi fiber connectors of two two/multi fiber cables, wherein the two two/multi fiber cables are connected end to end, wherein each of the two/multi fiber adapters have a key up to key down arrangement. The cables connect first equipment and to second equipment. A plurality of transition cable arrays can be included, each including a plurality of optical fibers, wherein a plurality of two/multi fiber connectors are at the first end, and wherein at least one MPO fiber connector is at the second end. MPO fiber adapters having a key up to key up arrangement, and a multi fiber trunk cable array is terminated at each end by an MPO fiber connector, wherein the multi fiber trunk cable array has a key up to key up arrangement, the multi fiber trunk cable array being connected to two of the MPO fiber adapters.

### CROSS-REFERENCE TO RELATED APPLICATION

This application is being filed on Jan. 6, 2023, as a PCT International application and claims the benefit of and priority to U.S. Patent Application Ser. No. 63/298,063, filed on Jan. 10, 2022, the disclosure of which is hereby incorporated by reference in its entirety.

### BACKGROUND

Optical fibers are commonly used for the transmission of signals of all sorts, including communication and data signals. Communications systems often transmit signals between transceivers (i.e., devices that can both transmit and receive optical signals) via different fibers in each direction. More specifically, one or more fibers will transmit signals from the first transceiver to the second, and one or more of the other fibers will transmit signals from the second transceiver to the first. In this manner, optical signals are not traveling along the same fiber in different directions.

This arrangement would be fairly simple to organize for two transceiver devices that are permanently optically connected, but in practice transceivers are typically connected through a much larger network of optical fibers, connectors and patch panels. For example, a common optical system includes multiple transceivers at one end, two fiber patch cords that are connected to the transceivers and to adapters mounted on a patch panel, a fan-out transition device connected to the adapters that connects to a multi fiber optic cable (e.g., 4, 8, 12, 16 and 24 fibers per cable, and the fibers may be in ribbon form) via an array adapter, a second fan-out transition device connected to the opposite end of the optic cable via a second array adapter, and corresponding transceivers connected via two fiber patch cords to the second fan-out transition device through adapters. Thus, it is important to be able to track individual optical fibers in the various devices and cables between the transceivers in order to ensure that the individual transceivers are connected as desired.

To ensure intermateability of cabling components and signal polarity, systems are defined wherein arrangements of fibers, cables, adapters and connectors with keys are provided in a certain order. For example, keys are provided on single or duplex connectors (e.g., SC, LC), and multi fiber push-on (MPO) fiber optic connectors to ensure proper intermateability with adapters. Another keying area is directed to maintaining optical fiber polarity within systems using breakout array cables, connectors and adapters, including MPOs. Systems built using these methods utilize fiber optic cables, adapters, transition devices and patch cords.

Examples of complications in fiber routing arise when the keyed connectors, such as single fiber simplex connectors, single fiber duplex connectors, and multi fiber MPO connectors such as 12, 16 or 24 fiber MPO connectors, are connected in the system. Polarity of the fibers is critical so that all of the elements in the system-patch cords, cable arrays, and trunk cables are connected to maintain proper polarity (e.g., transmit port to receive port) throughout the system. Such difficulties can lead to technician errors in optical routing when relying on fanout cables or other types of optical distribution systems in which incorrect or mismatched keys are presented.

### SUMMARY

The invention relates to a polarity maintaining connector system. In one aspect, a fiber routing system is provided including a plurality of two fiber cables terminated at each of a first end and a second and by a two fiber connector. In one preferred arrangement, each of the two fiber cables is a type B configuration having a key up to key down (opposed key) arrangement. In one preferred arrangement, a plurality of two fiber adapters connect to of the two fiber connectors together for linking between equipment. Each of the two fiber adapters include a key up to key down (opposed key) arrangement.

In one preferred arrangement, the two fiber connectors each include a pair of parallel fibers, terminated by parallel ferrules.

In one connector system, at least two of the two fiber adapters connect at least three of the two fiber cables to define two fiber pathways between point A and point B, wherein point A and point B can be the locations of telecommunications equipment, such as transceivers.

In one aspect, the telecommunications equipment includes transceivers for transmitting and receiving fiber optic signals on separate fibers. In one aspect, the transceiver includes pairs of fiber receiving connections wherein the pair of receiving connections defines a port. The port is keyed so that a connector can only be received by the port in one orientation.

In one aspect, equipment can be connected with polarity maintaining connectivity elements wherein type B links in the form of patch cords, arrays or trunks can be used with opposed key adapters. In such an arrangement, polarity is maintained even if there are additional links or segments such as patch cords, arrays or trunks added to the system between point A and point B. The same is correct if patch cords, arrays or trunks are removed from the system. In particular, an odd number of links or segments and an even number of links or segments do not impact the polarity of the connections at point A or point B.

In one aspect, a type B link can be in the form of a plurality of transition cable arrays each including a plurality of optical fibers (for example, at least 8 fiber, or at least 12 fibers). Each transition cable array extends from a first end to a second end wherein a plurality of two fiber connectors are at the first end, and at least one MPO fiber connector with a ferrule with multiple fibers is at the second end. A plurality of MPO fiber adapters having a key up to key up (aligned key) arrangement (type B) are connected to an MPO fiber connector of each transition cable array. A multi fiber trunk cable array is terminated at each of a first end and a second end by an MPO connector. The multi fiber truck cable array is a type B configuration in one example having a key up to key up arrangement. The multi fiber trunk cable array is connected to two of the MPO fiber adapters.

In some aspects, the transition cable arrays can be housed in a module having a housing with an interior, wherein a plurality of the two fiber connectors are located on one side of the housing and at least one MPO fiber connector is located on an opposite side of the housing. A plurality of two fiber adapters are located on the one side of the housing in one example mated to the two fiber connectors. At least one MPO fiber adapted adapter is located on the opposite side of the housing, in one example, mated to the MPO fiber connector.

In one example, the two fiber connectors have a key for polarity that cannot be changed. In one example the key is located on a connector body having two ferrules.

In one example, the plurality of transition cable arrays is a type U2 wiring pattern having outside in pairings of fibers.

In one example, the two fiber connectors can be mounted together with at least one other two fiber connector in a ganged arrangement.

In one example, the two fiber adapters can be mounted with at least one other two fiber adapter in a ganged arrangement.

In some cases, the two fiber connectors and the two fiber adapters can be in the form of additional fibers, such as four or more fibers. In one example, the fiber connectors can be sixteen (16) fiber connectors where the fibers are in a single ferrule body.

In some examples, the connector key is on a minor side of the connector body, such as on a 2 fiber connector or a 16 fiber connector.

### BRIEF DESCRIPTION OF THE DRAWINGS

FIG. 1 shows a first connectivity system with polarity maintaining connectivity devices.

FIG. 2 shows a second connectivity system with additional polarity maintaining connectivity devices.

FIG. 3 shows a third connectivity system with further polarity maintaining connectivity devices.

FIG. 4 shows the third connectivity system of FIG. 3 with an indication of a polarity maintaining connectivity device which can be used in place of a plurality of parallel two fiber patch cords.

FIG. 5 shows the third connectivity system of FIG. 3 showing portions of the polarity maintaining connectivity devices in the form of fiber optic modules.

FIG. 6 shows the third connectivity system of FIG. 3 showing cabling segments and mating adapters selected to maintain polarity throughout the system.

FIG. 7 shows a fourth connectivity system wherein polarity maintaining connectivity devices are not constructed in a manner to prevent a polarity mismatch in the illustrated system.

FIG. 8 shows a first embodiment of a two fiber connector.

FIG. 9 shows a second embodiment of a two fiber connector.

FIG. 10 shows a first embodiment of an adapter for use with four of the two fiber connectors of FIG. 8 on each end of the adapter.

FIG. 11 shows a transceiver with four of the two fiber connectors of FIG. 9.

FIG. 12 is a front perspective view an example module for housing a transition cable array and including front fiber optic connectors and duplex adapters, and rear MPO fiber connectors and MPO adapters.

FIG. 13 is a rear perspective view of the module of FIG. 12.

FIG. 14 is a first side view of the module of FIG. 12.

FIG. 15 is a further side view of the module of FIG. 12.

FIG. 16 is an exploded perspective view of the module of FIG. 12.

FIG. 17 is a top view of the module of FIG. 12 showing example fiber routing within the module housing.

FIG. 18 is a front view of the module of FIG. 12.

### DETAILED DESCRIPTION

Various fiber optical connectivity system are described herein and shown in the accompanying FIGS. that use fiber cabling, fiber connectors, and fiber adapters to connect fiber optic equipment. For example, the fiber optic equipment may in the form of transceiver units which include transmitters and receivers. In a transceiver system, typically fiber pathways are paired where one signal pathway is for transmitting signals in one direction from a first transceiver equipment to a second transceiver equipment, and a second fiber pathway is for transmitting signals in an opposite direction between the second transceiver equipment and the first transceiver equipment.

For cabling, connectors, and mating adapters with more than one fiber, managing polarity or relative positions of the fibers in the cabling, in the connectors, and in the mating adapters is important to avoid misconnected equipment. Managing the polarity over many links or segments (patch cords, cable arrays, trunk cables) becomes increasingly difficult as the number of segments end to end there are in the system. Systems with larger and larger numbers of fibers add further to the complexity. The various disclosed connectivity systems connect equipment, such as transceiver ports, with fiber optic links or segments, such as patch cords, cable arrays, and trunk cables. The patch cords, cable arrays, and trunk cables are keyed to provide a specific orientation for inter-mating fiber optic connectors (plugs) correctly with the mating fiber optic adapters (ports or sockets).

For transceiver connectivity systems, various fiber groupings can be utilized. For example, systems can use fiber groupings of two (2) fibers, four (4) fibers, eight (8) fibers, twelve (12) fibers, sixteen (16) fibers, and twenty four (24) fibers, and more. The fibers can also be grouped such as 2×8, and 3×8, for example, for use with 8, 12 and 24 fiber cables and connectors.

Fiber connectors and adapters in these systems can include two fiber connectors wherein the two fibers are arranged in parallel. For example the two fibers can be assigned a transmit function and the other a receive function. Some of these connectors have a connector body and two ferrules. These connectors also have a key for receipt in a mating two fiber adapter.

In preferred examples, the two fiber connectors will all have the same polarity with respect to each connector on opposite ends of a cable. In other words, even if the polarity is changeable, it is preferred that all of the polarities on any cables or cable assemblies not be modified and be identical to each other, in some embodiments.

In some example systems, the connectors can be attached to one another in a ganged arrangement, such as two (2), four (4), eight (8) or more. Adapters can also be in the form of a ganged arrangement including two (2), four (4), or eight (8), or more. Single connectors can be used in ganged adapters. Ganged connectors can be used in ganged adapters, although in different multiples of the ganged constructions. The ganged connectors and/or the ganged adapters can be integrally formed as a single body or formed with separate bodies and held together by mounting structure.

In some systems, large numbers of cables may be provided extending between equipment that may be located fairly close together in some cases, or in other cases in different locations, such as other rooms within a facility. In some cases, multi fiber trunks are used including 8 fiber, 12 fiber, 24 fiber, 144 fiber, 288 fiber, and more. MPO connectors with a single ferrule and multiple fibers within the ferrule are used for mating with MPO adapters to connect to other MPO connectors.

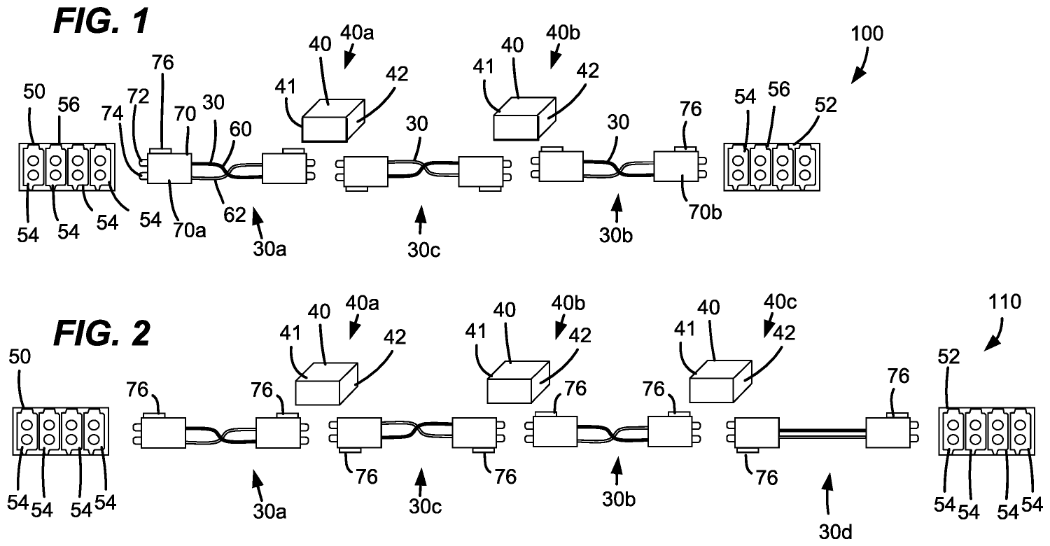

Referring now to FIG. 1, a first connectivity system 100 is shown. A plurality of links or segments 30 and mating adapters 40 connect first equipment 50 with second equipment 52. Both first and second equipment 50, 52 in this example are in the form of transceivers. Links 30a and 30b are in the form of two fiber patch cords. Each patch cord includes two fiber pathways 60, 62. Each of the fiber pathways 60, 62 are optical fibers terminated by a two fiber connector 70. Two fiber connector 70 includes two ferrules 72, 74. A key 76 is provided on each connector for maintaining polarity of fibers 60, 62. The key 76 is located on a side of the connector body, where the two ferrules are generally aligned with the key.

In the example shown, patch cords 30a, 30b are type B patch cords. Adapters 40 connect two connectors 70 together and maintain polarity with respect to keys 76 with an opposed key adapter (key up to key down). Opposed key adapter 40 includes a key up port 41 on one end and a key down port 42 on an opposite end for receiving appropriately oriented connectors 70. Connector 70a is received in a port 54 of equipment 50. Connector 70b is received in a port 54 of second equipment 52. Note that for both first and second equipment 50, 52, the keys 56 are up.

Link 30c of FIG. 1 can be in the form of a two fiber patch cord, if desired. Link 30c can also be in the form of a larger link with more components, and a relatively longer link such as a trunk cable having more than two fibers. Such a link 30c can be a grouping of fibers from a plurality of parallel patch cords 30a, 30b for connecting first equipment 50 to second equipment 52 in a compact arrangement.

With the arrangement of FIG. 1, the polarity of the two fibers at each of the ports 54 of first and second equipment 50, 52 is maintained for the transmit and receive pathways extending between the first equipment 50 and second equipment 52. In the example of FIG. 1, polarity is maintained through the use of polarity maintaining connectivity devices of the same type B patch cords 30a, 30b, a type B link 30c, and the opposed key adapters 40.

Referring now to FIG. 2, a similar connectivity system 110 is shown to system 100 of FIG. 1, except that an extra patch cord 30d has been added to the system. As shown, by using a type B patch cord 30d, and an additional opposed key adapter 40c, polarity is maintained between first equipment 50 and second equipment 52. FIG. 1 shows an even number of patch cords 30a, 30b. FIG. 2 shows an odd number of patch cords 30a, 30b, 30d.

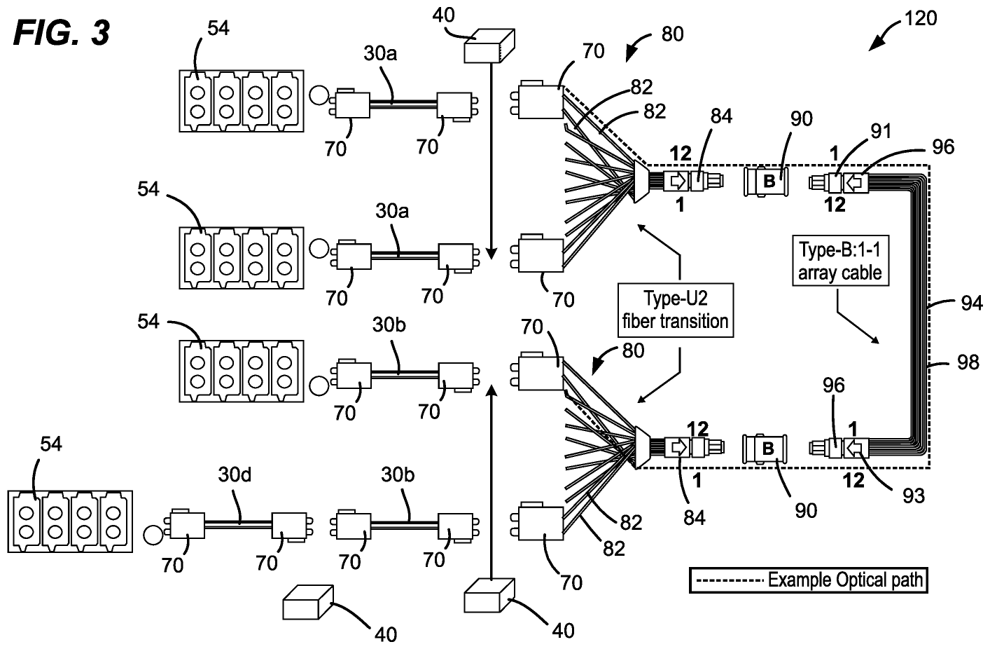

Referring now to FIG. 3, a connectivity system 120 is provided to illustrate systems that combine two fiber patch cords 30a, 30b with transition cable arrays 80 that transition between two fiber connectors 70 and an MPO connector 84, such as to allow for multi fiber trunks 94 having greater than two fibers, such as 12, 24, 144, 288, etc. Each transition cable array 80 includes a plurality of optical fibers 82, such as 12 in the illustrated example, extending between a plurality of two fiber connectors 70 and an MPO connector 84. Each of the two fiber connectors 70 of cable transition cable array 80 is connectable to one of the two fiber adapters 40. MPO connectors 84 are connectable to MPO adapters 90. As shown, MPO adapters 90 are in the form of aligned keys (key up to key up) MPO adapters. A multi fiber trunk cable array 94 includes a multi fiber cable 98 terminated at a first and 91 with an MPO connector 96 and at a second end 93 with an MPO connector 96. One example signal path is shown in dotted lines. Positions 1 and 12 of the cables are also labeled.

The cable transition cable array 80 is arranged in a U2 fiber routing (outside in pairing) with respect to MPO adapter 84.

With respect to FIGS. 1-3, it is to be appreciated that the illustrated systems 100, 110, 120 are shown including a few cables, for simplification. The systems 100, 110, 120 are more likely to include many multiples of the connectivity devices and cables for a datacenter or other application where hundreds or thousands of transceivers or other connectivity port may be housed. Multi fiber trunk cable array 94 can have multiples of cables 98 within a single jacket, and terminating connectors 96 as desired for the datacenter or other application.

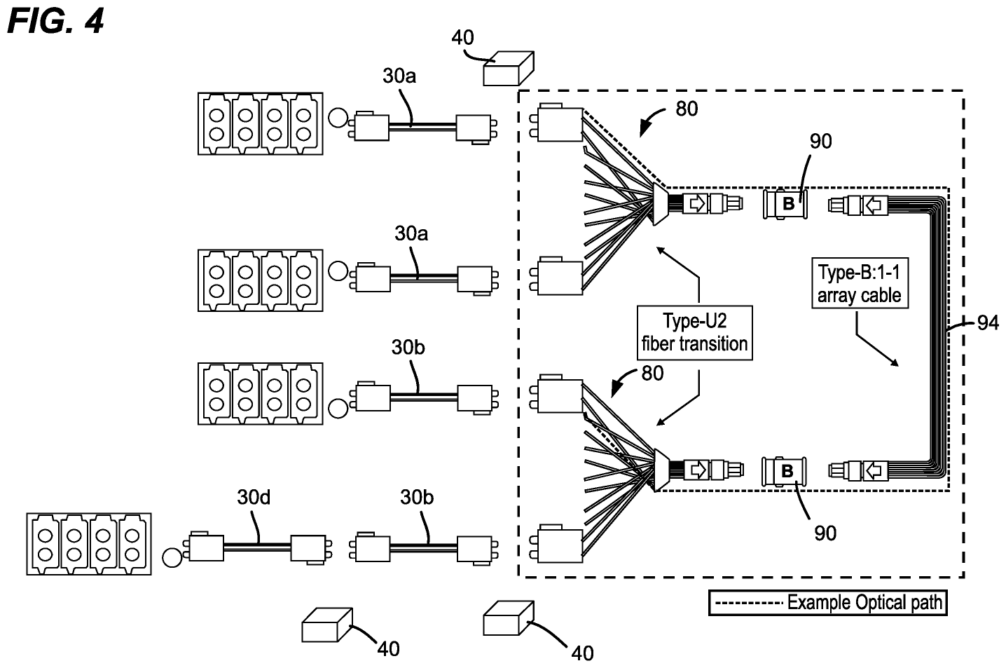

Referring now to FIG. 4, a similar layout to that of FIG. 3 is shown. In FIG. 4, a box 200 illustrates a connectivity device for maintaining polarity while managing a bulk amount of fiber optic cables. Device 200 is also shown as a type B link 30c in

FIG. 1 in the form of a two fiber patch cord.

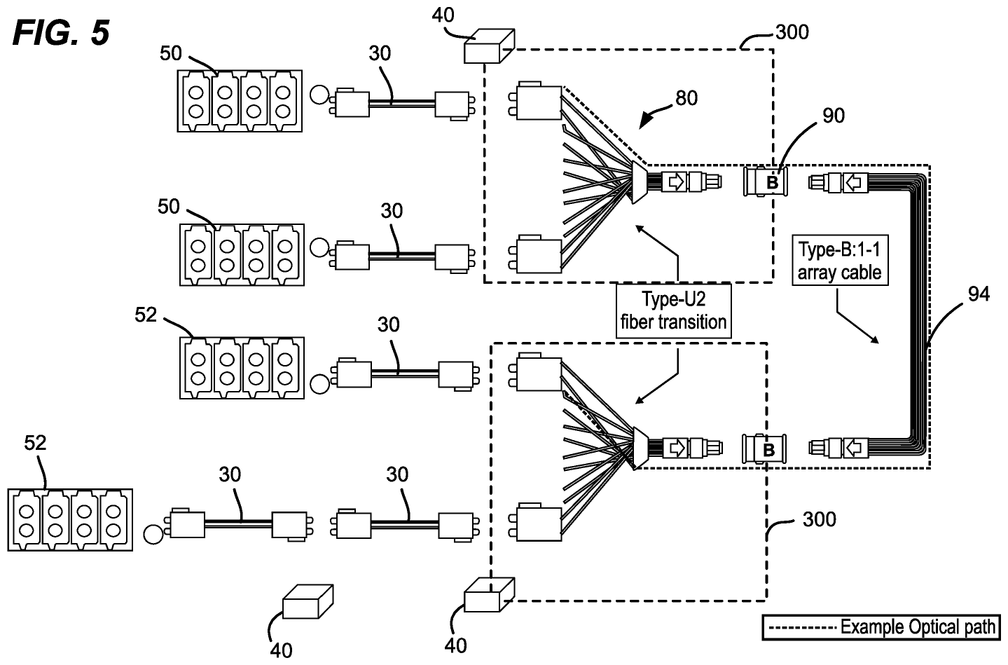

Referring now to FIG. 5, a similar layout of signal pathways is shown to the layouts shown in FIGS. 3 and 4. FIG. 5 shows example boxes 300 that are each provided as a polarity maintaining device. These devices can be in the form of a module including a plurality of two fiber adapters 40, a transition cable array 80, and an MPO adapter 90 which can be conveniently packaged in a closed housing to form a modular device. Adapters 40 are connectable to patch cords 30 which are connectable to additional adapters 40 and additional patch cords 30 and equipment 50, 52.

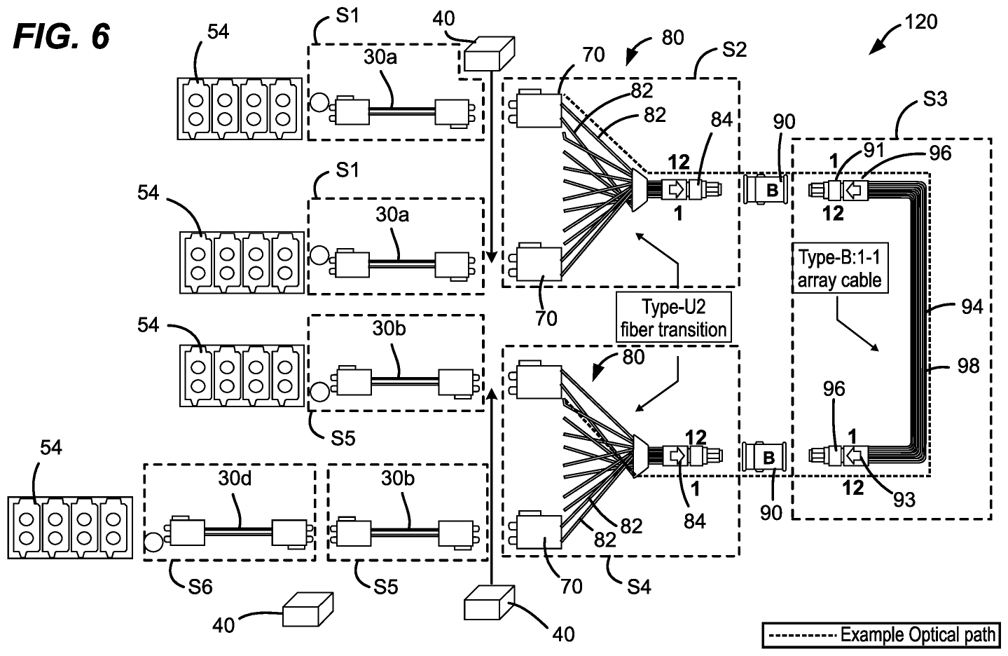

FIG. 6 shows the links or segments between the equipment 50, 52. FIG. 6 is similar to the layouts of FIGS. 3-5. As shown, there are five (5) segments, labeled S1, S2, S3, S4, and S5, between equipment 50 and equipment 52b. There are six (6) segments between equipment 50 and equipment 52c. An extra segment S6 is shown. As shown, by using opposed key adapters 40, type B patch cords, identical layouts for the transition cable arrays, polarity is maintained regardless of how many segments are between equipment 50 and equipment 52.

For FIGS. 1-6, it is to be noted that all of the ports 54 of equipment 50 and equipment 52 have the same orientations. The two ferrule ports and connectors have the fibers/ferrules aligned in a vertical plane in the example shown. Polarity maintaining connectivity devices of the patch cords 30a, 30b, 30c, 30d, the two fiber adapters 40, the transition cable arrays 80 can be all the same parts with the same polarity. Any of the patch cords 30a, 30b, 30c, 30d, the two fiber adapters 40, and the transition cable arrays 80 could be switched out with another one of the respective patch cords 30a, 30b, 30c, 30d, the two fiber adapters 40, and the transition cable arrays 80 without losing polarity, or needing an adapting part to fix a polarity mismatch.

It is to be noted that the length of the segments can be varied as needed or desired system to system or within a system. It also to be noted that the form factor of the connectors and adapters can be varied as needed or desired system to system or within a system. For example, the connectors can be different inside a module from those not inside the module. The adapters on a patch panel can be different from the adapters used on a module. The benefits of the systems of FIGS. 1-6 are particularly noticed when the polarity if the components and segments is followed end to end in the noted systems.

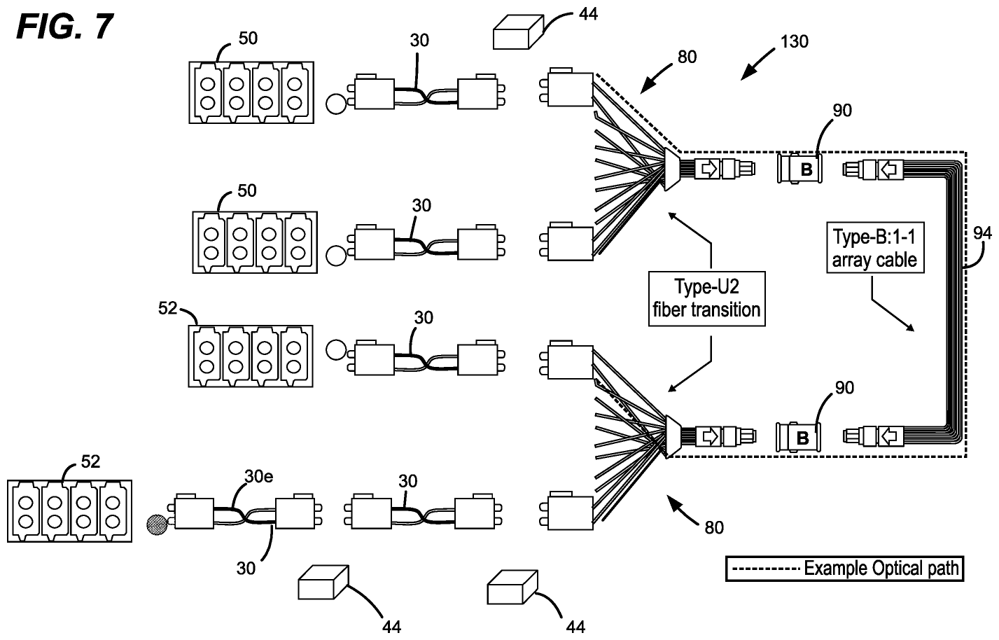

Referring now to FIG. 7, an alternative connectivity system 130 is shown wherein polarity maintaining connectivity devices are not properly arranged such that a mismatched polarity is presented as shown with respect to patch cord 30e. The patch cords shown in FIG. 7 are all of a similar construction to patch cords 30 illustrated in FIGS. 1-6. Adapters 44 are of a different design from adapters 40 described above.

Adapters 44 are indicated as aligned key (key up to key up) adapters. Polarity is maintained with respect to some of the fiber links, but not the link including patch cord 30e. If one were to have connectivity system 130, polarity problems arise unless a special patch cord, such as a type A patch cord, is used instead of type B patch cord 30e. However such would require the use of two different patch cords be used within system 130.

With respect to the systems of FIGS. 1-6, polarity is maintained between equipment 50, 52 by using one type of MPO adapters, MPO type B adapters. In these same systems only one type of trunk or array cable, type B trunks or array cables are used. Also, only one type of transition cable array is needed, whether in module form or other format, including the arrays having an identical orientation and layout relative to one another. Also, these systems utilize only one type of patch cord, type B patch cords. It is preferred that polarity not be changed on any of these patch cords to avoid confusion and mismatched polarities. In some cases, the patch cords can be selected of the type that are permanently fixed with respect to polarity of the connectors on each end. In the noted systems, only one type of two fiber adapters, opposed key adapters, are utilized for connecting to the connectors on the patch cords, or the connectors in the transition cable arrays. As noted, an odd or even number of links 30 do not impact polarity. Compare to FIG. 7 where an extra link 30 affected polarity and required modification to the system with respect to polarity of an element due to the extra patch cord 30e. The circles near equipment 50, 52 illustrate transmit/receive paths that are correct (FIGS. 3-6), and one that is not correct (FIG. 7, patch cord 30e).

By use of the described systems, a wrong polarity at some point in the system is avoided. With the above described systems, polarity is simplified for initial set up and future modifications to the system for the technician. The technician on day one or day two need to access only one kind of patch cord, only one kind of patch cord adapter, only one kind of fiber trunk or cable array, only one kind of MPO adapter, and only one kind of fiber transition cable array. In the case of a wrong polarity facing a technician, the technician may have difficulty figuring out where the polarity problem is and how to fix the polarity problem. Once identified, the technician is faced with a variety of solutions to fix the problem. Complexities arise however, if the system uses different patch cords, different adapters, different transition cable arrays, and different multi fiber trunk cable arrays.

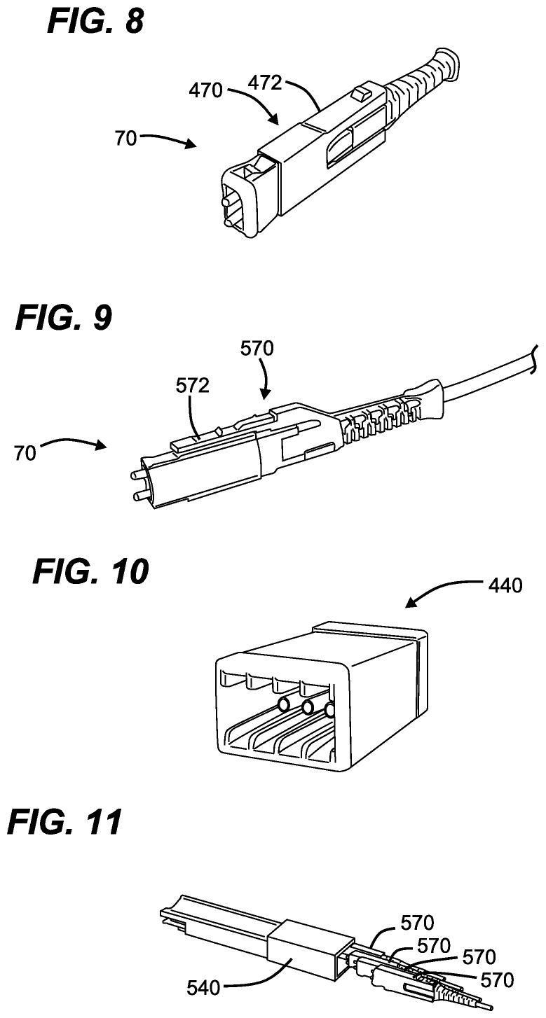

Referring now to FIGS. 8-11, examples of two fiber connectors 70 are shown. FIG. 8 shows an SN style two fiber and two ferrule connector 470 with a key 472 by Senko. FIG. 9 shows an MDC style two fiber and two ferrule connector 570 with a key 572 by USConec. FIG. 10 shows a first embodiment of an adapter 440 for use with four of the two fiber connectors 470 of FIG. 8 on each end of the adapter. FIG. 11 shows a transceiver 540 with four of the two fiber connectors 570 of FIG. 9. Various patents show two fiber connector devices including: U.S. Pat. No. 10,281,669; 10,520,689; 10,520,690; 9,829,653; 10,281,668; 10,690,864; 11,016,250; 11,016,251; 11,112,567; 11,119,281, which are herein incorporated by reference for two fiber connectivity devices that may be used in the systems of the present disclosure.

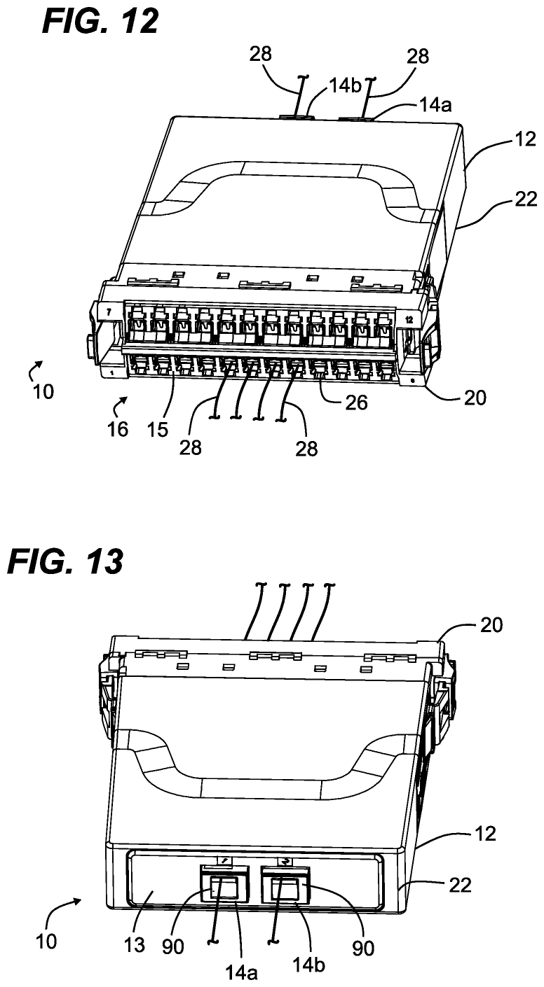

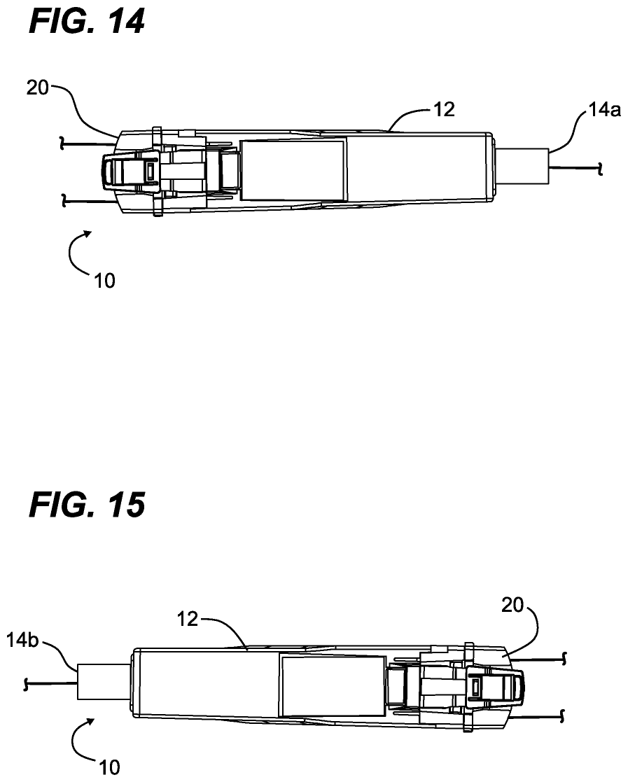

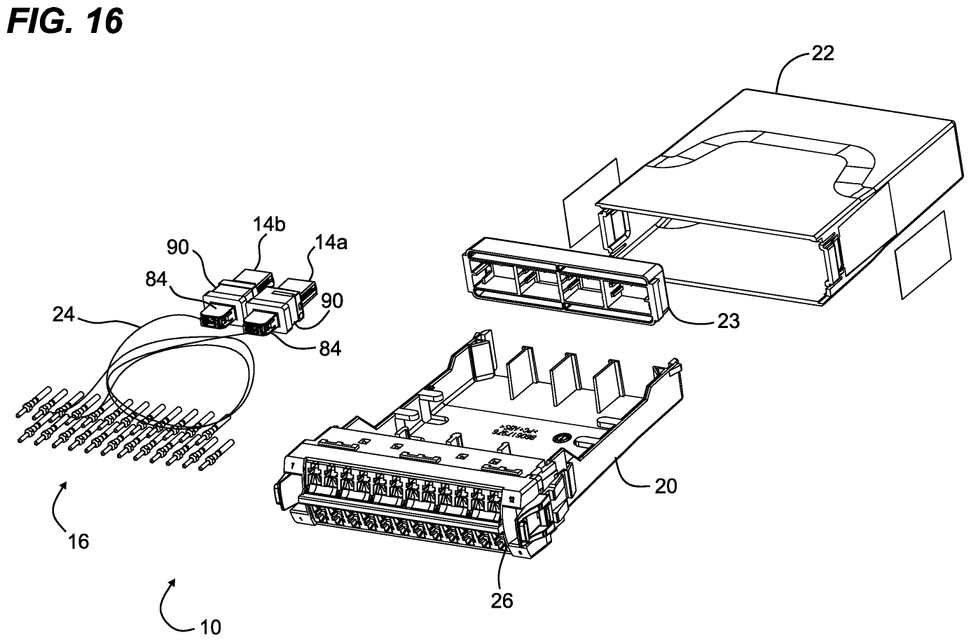

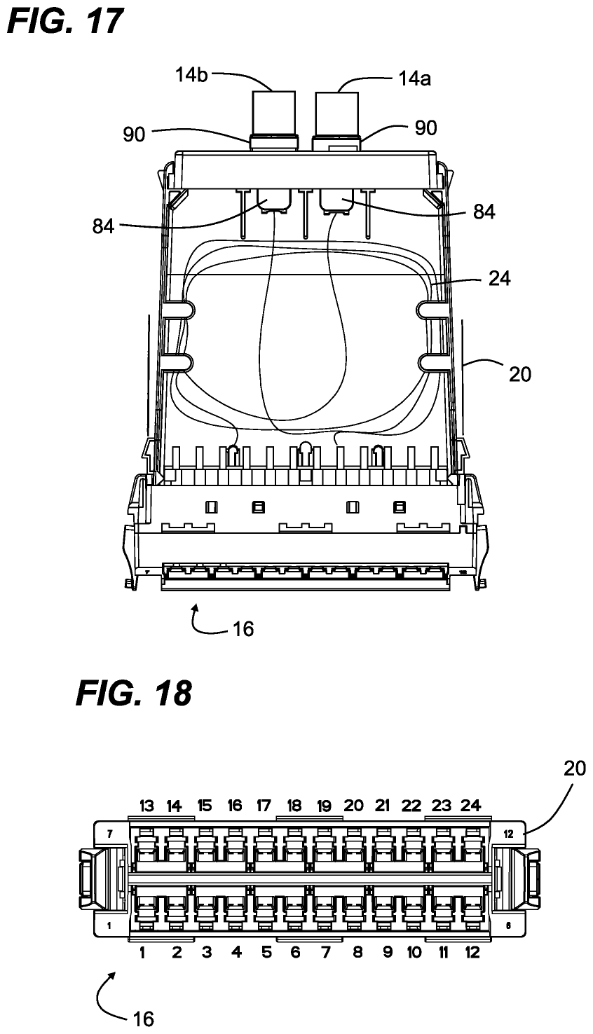

Referring now to FIGS. 12-18, an example of a fiber distribution module 10 is illustrated having the function of device 300 of FIG. 5. Module 10 includes a housing 12 having opposed first and second sides. First side 13 of the housing has one or more MPO connectors 14 and adapters 90 disposed thereon. In the example shown, two 12 fiber MPO connectors 14a, 14b are illustrated. In the illustrated embodiment, plurality of LC connectors 16 are disposed on the second side 15 of the housing 12. The plurality of LC connector 16 are disposed into rows 18a,b. In the example shown 12 LC connectors 16 are disposed in each of the two rows. In the example shown, the housing can include a cassette 20 and a shell 22. The cassette 20 includes the second side, in which the LC connectors can be mounted in adapters 26. A face plate 23 can be positioned within the shell 22 and the MPO adapters 90 can extend through the face plate 23, being removably mounted at the first side of the housing 12. Fibers 24 can be positioned within the shell 22 and extend between the MPO connectors 84 and the LC connectors 16. The shell 22 can in the embodiment shown, feature a snap fit connection over the cassette 20, to encase and protect the fibers 24. Optionally, the fibers 24 are of adequate length to form a fiber loop within the enclosure seen best in FIG. 17 which can allow for movement and or replacement of the LC connectors or MPO connectors as may be desired. As shown in FIG. 18, the LC connector ports are numbered and arranged consecutively in the first and second rows.

While this module 10 illustrates the front connections being in the form of LC connectors and adapters, the pairs of LC connectors and respective adapter ports can be replaced with connectors 70 and adapters 40 as described above. One example of an LC duplex connector that can be used at a front side of adapters 26 is shown in U.S. Pat. No. 10,067,301, the disclosure of which is hereby incorporated by reference. An LC Uniboot connector similar to the noted patent, with two ferrules, is available from CommScope, Inc. The LC connectors internal to the module 10 can be smaller in form than the above-noted LC duplex connectors. They can be in the form of just ferrules, and hubs, or they may have a body and no spring and/or no boot. The same can be done with respect to external connectors 70 and internal module connectors mated together by adapters 40.

In FIGS. 12-18, exteriorly located fibers are shown as fibers 28.

The fiber routing systems can also be implemented wherein the multi fiber connectors are sixteen (16) fiber single ferrule connectors. In one example, the 16 fiber single ferrule connectors include a key along a minor side of a connector body.

Regardless of the connector format, using identical plug ends for patch cords and connectors, and identical ports for adapters for connectivity components helps reduce or eliminate polarity mismatches between equipment.

The above specification, examples and data provide a complete description of the manufacture and use of the composition of the invention. Since many embodiments of the invention can be made without departing from the spirit and scope of the invention, the invention resides in the claims hereinafter appended.

1. A fiber routing system comprising:
a. a plurality of two/multi fiber cables terminated at each of a first end and a second end by a two/multi fiber connector, wherein each of the two/multi fiber cables is a type B configuration having a key up to key down arrangement;
b. a plurality of two/multi fiber adapters each connecting two of the two/multi fiber connectors of two two/multi fiber cables, wherein the two two/multi fiber cables are connected end to end, wherein each of the two/multi fiber adapters have a key up to key down arrangement;
c, wherein the two/multi fiber connectors each include at least one pair of parallel fibers;
d, wherein at least two (2) of the two/multi fiber adapters connect at least three (3) of the two/multi fiber cables to define at least two (2) fiber pathways between a point A and a point B.

2. The fiber routing system of claim 1, wherein at least two (2) fiber pathways (parallel, Transmit/Receive) are defined between a first equipment and a second equipment, wherein:
a. the first equipment includes a first two/multi fiber port;
b. a first two/multi fiber connector of a first two/multi fiber cable is connected to the first two/multi fiber port of the first equipment, the first two/multi fiber cable extending to a second two/multi fiber connector of the first two/multi fiber cable (element 1/link 1);
c. then to a first two/multi fiber adapter;
d. then to a first two/multi fiber connector of a further two/multi fiber cable, then to a second two/multi fiber connector of the further two/multi fiber cable (element 2/link 2);
e. then to a second two/multi fiber adapter;
f. then to a first two fiber/multi connector of a second two/multi fiber cable, then to a second two/multi fiber connector of the second two/multi fiber cable (element 3/link 3);
g. then to a first two/multi fiber port of the second equipment.

3. The fiber routing system of claim 2, further comprising:
a. a plurality of transition cable arrays, each transition cable array including:
a plurality of optical fibers (at least 8 fiber, at least 12 fibers);
wherein each transition cable array extends from a first end to a second end, wherein a plurality of two/multi fiber connectors are at the first end, and wherein at least one MPO fiber connector for a ferrule with at least twelve fibers is at the second end;
b. a plurality of MPO fiber adapters of a type B configuration having a key up to key up arrangement, one of the MPO adapters being connected to the at least one MPO fiber connector of each transition cable array;
c. a multi fiber trunk cable array of at least 8 or 12 fibers is terminated at each of a first end and a second end by an MPO fiber connector, wherein the multi fiber trunk cable array is a type B configuration having a key up to key up arrangement, the multi fiber trunk cable array being connected to two of the MPO fiber adapters.

4. The fiber routing system of claim 3, wherein two fiber pathways (parallel, Transmit/Receive) are defined between the first equipment and the second equipment:
a first two/multi fiber port of the first equipment;
a first two/multi fiber connector of a first two/multi fiber cable connected to the first two/multi fiber port of the first equipment;
the first two/multi fiber cable extending to a second two/multi fiber connector of the first two/multi fiber cable (element 1/link 1);
then to a first two/multi fiber adapter;
then to a first two/multi fiber connector of a first transition cable array then to a first MPO fiber connector of the first transition cable array;
then to a first MPO fiber adapter;
then to a first MPO fiber connector of a multi fiber trunk cable array to a second MPO fiber connector of the multi fiber trunk cable array;
then to a second MPO fiber adapter;
then to a second MPO fiber connector of a second transition cable array to a second two/multi fiber connector of the second transition cable array (element 2/link 2);
then to a second two/multi fiber adapter;
then to a second two fiber/multi connector of a second two/multi fiber cable cord then to a first two/multi fiber connector of the second two/multi fiber cable (element 3/link 3);
then to a first two/multi fiber port of the second equipment.

5. The fiber routing system of claim 3, wherein element a.) is arranged in a module including a housing, wherein the two/multi fiber connectors are located on one side of the housing, and the at least one MPO fiber connector is located on an opposite side of the housing.

6. The fiber routing system of claim 5, wherein a plurality of the two/multi fiber adapters are located on the one side of the housing.

7. The fiber routing system of claim 5, wherein at least one MPO fiber adapter is located on the opposite side of the housing.

8. The fiber routing system of claim 1, wherein the two/multi fiber connectors have a polarity for a connector body relative to a key that cannot be changed.

9. The fiber routing system of claim 1, further comprising a third two/multi fiber adapter connected to the first or the second two/multi fiber cable, and the third two/multi fiber adapter further connected to a third two/multi fiber cable between point A and point B.

10. The fiber routing system of claim 3, wherein each of the plurality of transition cable arrays is a type U2 wiring pattern (with outside in pairings).

11. The fiber routing system of claim 1, further comprising:
a. a plurality of transition cable arrays, each transition cable array including:
a plurality of optical fibers (at least 8 fibers, at least 12 fibers);
wherein each transition cable array extends from a first end to a second end, wherein a plurality of two/multi fiber connectors are at the first end, and wherein at least one MPO fiber connector for a ferrule with at least twelve fibers is at the second end;
b. a plurality of MPO fiber adapters of a type B configuration having a key up to key up arrangement, one of the MPO adapters being connected to the at least one MPO fiber connector of each transition cable array;
c. a multi fiber trunk cable array of at least 8/12 fibers is terminated at each of a first end and a second end by an MPO fiber connector, wherein the multi fiber trunk cable array is a type B configuration having a key up to key up arrangement, the multi fiber trunk cable array being connected to two of the MPO fiber adapters.

12. A fiber routing system comprising:
a. a plurality of two/multi fiber cables terminated at each of a first end and a second end by a two/multi fiber connector, wherein each of the two/multi fiber cables is a type B configuration having a key up to key down arrangement;
b. a plurality of two/multi fiber adapters each connecting two of the two/multi fiber connectors of two two/multi fiber cables, wherein the two two/multi fiber cables are connected end to end, wherein each of the two/multi fiber adapters have a key up to key down arrangement;
c. a first equipment and a second equipment, wherein: the first equipment includes a first two/multi fiber port, and the second equipment includes a first two/multi fiber port;
d. a plurality of transition cable arrays, each transition cable array including a plurality of optical fibers (at least eight (8), at least twelve (12) fibers), wherein each transition cable array extends from a first end to a second end, wherein a plurality of two/multi fiber connectors are at the first end, and wherein at least one MPO fiber connector for a ferrule with at least twelve fibers is at the second end;
e. a plurality of MPO fiber adapters of a type B configuration having a key up to key up arrangement, one of the MPO adapters being connected to the at least one MPO fiber connector of each transition cable array;
f. a multi fiber trunk cable array of at least 8/12 fibers is terminated at each of a first end and a second end by an MPO fiber connector, wherein the multi fiber trunk cable array is a type B configuration having a key up to key up arrangement, the multi fiber trunk cable array being connected to two of the MPO fiber adapters,
wherein two fiber pathways (parallel, Transmit/Receive) are defined between the first equipment and the second equipment:
a first two/multi fiber connector of a first two/multi fiber cable connected to the first two/multi fiber port of the first equipment;
the first two/multi fiber cable extending to a second two/multi fiber connector of the first two/multi fiber cable (element 1/link 1);
then to a first two/multi fiber adapter;
then to a first two/multi fiber connector of a first transition cable array;
then to a first MPO fiber connector of the first transition cable array;
then to a first MPO fiber adapter;
then to a first MPO fiber connector of a multi fiber trunk cable array to a second MPO fiber connector of the multi fiber trunk cable array;
then to a second MPO fiber adapter;
then to a second MPO fiber connector of a second transition cable array to a second two/multi fiber connector of the second transition cable array (element 2/link 2);
then to a second two/multi fiber adapter;
then to a second two fiber/multi connector of a second two/multi fiber cable cord then to a first two/multi fiber connector of the second two/multi fiber cable (element 3/link 3);
then to the first two/multi fiber port of the second equipment.

13. The fiber routing system of claim 12, wherein element d.) is arranged in a module including a housing, wherein the two/multi fiber connectors are located on one side of the housing, and the at least one MPO fiber connector is located on an opposite side of the housing.

14. The fiber routing system of claim 13, wherein a plurality of the two/multi fiber adapters are located on the one side of the housing.

15. The fiber routing system of claim 13, wherein at least one MPO fiber adapter is located on the opposite side of the housing.

16. The fiber routing system of claim 12, wherein the two/multi fiber connectors have a polarity for a connector body relative to a key that cannot be changed.

17. The fiber routing system of claim 12, further comprising a third two/multi fiber adapter connected to the first or the second two/multi fiber cable, and the third two/multi fiber adapter further connected to a third two/multi fiber cable between point A and point B.

18. The fiber routing system of claim 12, wherein each of the plurality of transition cable arrays is a type U2 wiring pattern (with outside in pairings).

19. The fiber routing systems of claim 1, wherein the two/multi fiber connectors have a polarity for a connector body relative to a key that can be changed, but none of the polarities are changed.

20. The fiber routing systems of claim 1, wherein the multi fiber connectors are 16 fiber single ferrule connectors.

21. The fiber routing systems of claim 19, wherein the 16 fiber single ferrule connectors include a key along a minor side of a connector body.
